(19) United States
(12) Patent Application Publication
(10) Pub. No.: US 2026/0217373 A1
(43) Pub. Date: Jul. 30, 2026

(54) TAPERED SEAT FRAME LEG

(71) Applicant: B/E Aerospace, Inc., Winston-Salem, NC (US)

(72) Inventors: Ryan A. Myers, Winston-Salem, NC (US); Conner A. Christensen, Winston-Salem, NC (US); Brian P. Wenger, Kernersville, NC (US); Lyle T. Davis, Pfafftown, NC (US); Sachin Tarlekar, Greensboro, NC (US)

(21) Appl. No.: 19/461,328

(22) Filed: Jan. 27, 2026

Related U.S. Application Data
(60) Provisional application No. 63/749,944, filed on Jan. 27, 2025.

(51) Int. Cl. B64D 11/06

(52) U.S. Cl. CPC B64D 11/0648; B64D 11/064; B64D 11/0641; B64D 11/0696

(57) ABSTRACT

A leg frame may include a first mounting bracket, where the first mounting bracket includes a track mounting hole, where the track mounting hole includes a cavity defined by one or more sidewalls, where the cavity includes a tapered portion. The leg frame may include a second mounting bracket arranged opposite the first mounting bracket. The leg frame may include a track stud, where the cavity of the track mounting hole is configured to receive at least a portion of the shaft of the track stud, where at least the portion of the shaft of the track stud is configured to contact the tapered portion of the cavity when a load is applied to the tapered seat leg frame.

### CROSS-REFERENCE TO RELATED APPLICATIONS

The present application claims the benefit under 35 U.S.C. § 119(e) of U.S. Provisional Application No. 63/749,944, filed January 27, 2025, which is herein incorporated by reference in its entirety.

### TECHNICAL FIELD

The present disclosure is directed towards a seat frame, and more particularly to, a tapered seat frame leg for an aircraft seat.

### BACKGROUND

Maintaining structural integrity under extreme load conditions is often difficult in passenger seating. For example, during high-impact events (such as a crash or hard landing), the support leg of a seat frame is subjected to intense forces. Conventional designs often exhibit structural weaknesses at the front attachment area, where excessive compressive strain and contact-induced deformation may occur under such loads. For instance, the attachment stud may press or twist into the leg’s structure, causing localized material deformation. Such deformation may indicate that the stresses are beyond the normal design limits of the leg, such that the leg may be at risk of buckling or cracking under peak load conditions. If a seat frame leg deforms or fails during a high-load event, the seat’s attachment to the vehicle structure can be compromised, increasing the risk of passenger injury.

As such, there is a need for a system or method that cures one or more shortfalls of the previous approaches.

### SUMMARY

A tapered seat leg frame is disclosed, in accordance with one or more embodiments of the present disclosure. In embodiments, the tapered seat leg frame includes: a first mounting bracket, where the first mounting bracket includes a track mounting hole, where the track mounting hole includes a cavity defined by one or more sidewalls, where the cavity includes a tapered portion; a second mounting bracket arranged opposite the first mounting bracket; and a track stud including a shaft including at least a first end and a second end, where the cavity of the track mounting hole is configured to receive at least a portion of the shaft of the track stud, where at least the portion of the shaft of the track stud is configured to contact the tapered portion of the cavity when a load is applied to the tapered seat leg frame.

In some embodiments, an angle of the cavity between a central axis of the track stud and a tapered sidewall within the tapered portion of the cavity may be approximately 15 degrees.

In some embodiments, a distance between an edge of a shaft of the track stud and a sidewall within the cavity of the track mounting hole may be at least 0.04 inches.

In some embodiments, the first mounting bracket may further include a fastener hole configured to receive a fastener, where the fastener may be configured to secure the track stud within the cavity of the track mounting hole and the fastener hole.

In some embodiments, the fastener may include a barrel nut.

In some embodiments, the track stud may be coupled to an anti-rattle device, where the anti-rattle device may be configured to securely hold the tapered seat leg frame in place during one or more loading conditions.

In some embodiments, the first end of the track stud may be configured to couple to a track on a floor of an aircraft cabin.

In some embodiments, the first end of the track stud may include a lobe protrusion, where a shape of the lobe protrusion may be complementary to a lobe shape of a track.

An aircraft seat is disclosed, in accordance with one or more embodiments of the present disclosure. In embodiments, the aircraft seat includes: a seat frame including a seatback and a seat pan; and a base assembly configured to couple the seat frame to a floor of an aircraft cabin, where the base assembly includes one or more tapered seat leg frames. In embodiments, each tapered seat leg frame includes: a first mounting bracket, where the first mounting bracket includes a track mounting hole, where the track mounting hole includes a cavity defined by one or more sidewalls, where the cavity includes a tapered portion; a second mounting bracket arranged opposite the first mounting bracket; and a track stud including a shaft including at least a first end and a second end, where the cavity of the track mounting hole is configured to receive at least a portion of the shaft of the track stud, where at least the portion of the shaft of the track stud is configured to contact the tapered portion of the cavity when a load is applied to each tapered seat leg frame.

In some embodiments, the base assembly may further include one or more structural beams configured to couple the seat frame to the floor of the aircraft cabin via the one or more tapered seat leg frames.

In some embodiments, an angle of the cavity between a central axis of the track stud and a tapered sidewall within the tapered portion of the cavity may be approximately 15 degrees.

In some embodiments, a distance between an edge of a shaft of the track stud and a sidewall within the cavity of the track mounting hole may be at least 0.04 inches.

In some embodiments, the first mounting bracket may further include a fastener hole configured to receive a fastener, where the fastener may be configured to secure the track stud within the cavity of the track mounting hole and the fastener hole.

In some embodiments, the fastener may include a barrel nut.

In some embodiments, the track stud may be coupled to an anti-rattle device, where the anti-rattle device may be configured to securely hold each tapered seat leg frame in place during one or more loading conditions.

In some embodiments, the first end of the track stud may be configured to couple to a track on the floor of the aircraft cabin.

In some embodiments, the first end of the track stud may include a lobe protrusion, where a shape of the lobe protrusion may be complementary to a lobe shape of a track.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are examples and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples ("examples") of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 illustrates a schematic view of a tapered seat frame leg, in accordance with one or more embodiments of the present disclosure.

FIG. 2A illustrates a schematic view of the tapered seat frame leg including an attachment sub-system, in accordance with one or more embodiments of the present disclosure.

FIG. 2B illustrates a schematic view of the tapered seat frame leg including the attachment sub-system, in accordance with one or more embodiments of the present disclosure.

FIG. 2C illustrates a cross-sectional view of the tapered seat frame leg including the attachment sub-system, in accordance with one or more embodiments of the present disclosure.

FIG. 2D illustrates a cross-sectional view of the tapered seat frame leg, in accordance with one or more embodiments of the present disclosure.

FIG. 2E illustrates a cross-sectional view of the tapered frame leg including the attachment sub-system, in accordance with one or more embodiments of the present disclosure.

FIG. 3A illustrates a conventional leg including a high area of compressive strain on a front portion of the leg.

FIG. 3B illustrates the tapered leg frame including localized compressive strain across a body of the tapered leg frame, in accordance with one or more embodiments of the present disclosure.

FIG. 4 illustrates an aircraft seat including the tapered seat frame leg, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein, a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein, any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of or sub-combination of two or more such features, along with any other features which may not necessarily be expressly described or inherently present in the instant disclosure.

Maintaining the structural integrity of passenger seating under extreme load conditions is challenging. During high-impact events such as a crash or hard landing, a seat frame’s support leg is subjected to intense forces. Conventional seat designs often exhibit structural weaknesses at the front attachment area of the leg, where excessive compressive strain and contact-induced deformation can occur under such loads. For instance, the attachment stud may press or twist into the leg’s structure, causing localized material deformation. Such deformation indicates that stresses have exceeded the leg’s normal design limits, putting the leg at risk of buckling or cracking under peak load conditions. If a seat frame leg deforms or fails during a high-load event, the seat’s attachment to the vehicle structure can be compromised, increasing the risk of passenger injury.

In addition to these safety concerns, aircraft seats must meet strict regulatory criteria. For example, commercial aircraft seats are required to pass rigorous dynamic crash testing (e.g., a 16G impact test) to demonstrate their structural integrity and ability to protect an occupant during a simulated crash scenario. These dynamic tests measure how well the seat withstands significant forces and how they affect the loads on an occupant’s body, as defined by FAA regulations (14 CFR § 25.562). Meeting these standards ensures that the seat can endure severe impact conditions while minimizing potential injuries to passengers.

However, modern aircraft seats have become more complex and substantially heavier, which creates additional challenges in passing the required dynamic tests. For instance, some contemporary business-class seats may be about 30% wider than traditional designs, resulting in roughly a 30% increase in weight. This extra weight leads to higher inertial forces on the seat during a crash scenario. As a result, the seat frame experiences extra loading during dynamic testing, making it even more difficult for conventional designs to satisfy the stringent 16G performance requirements.

Under conventional seat frame designs, a common failure mode during a 16G event involves the front attachment stud of the seat leg pivoting (or “rolling”) into the sidewall of its mounting structure. When the seat is subjected to extreme deceleration, the front stud can twist against the edges of the mounting hole, leading to very high localized compressive strain at the point of contact. This concentration of stress on the leg’s critical structural features can cause those features to crack or otherwise fail. Indeed, such contact-induced cracking in the front leg area has been a frequent cause of failure in dynamic crash tests for traditional seat frames.

As such, it would be desirable to provide a tapered seat frame for an aircraft seat configured to address one or more shortcomings of the previous approaches. The tapered seat frame should allow the seat to pass dynamic testing (e.g., 16G dynamic load testing). For example, the tapered seat frame may allow the stud to distribute the load more evenly across the face of the leg, such that the front stud does not pivot into the sidewall. By avoiding such localized stress concentrations, the tapered seat frame can reduce the risk of material deformation or cracking under peak loads. In this regard, the seat frame may withstand crash-level forces without failure, thereby improving the likelihood of passing rigorous dynamic testing and ultimately enhancing passenger safety.

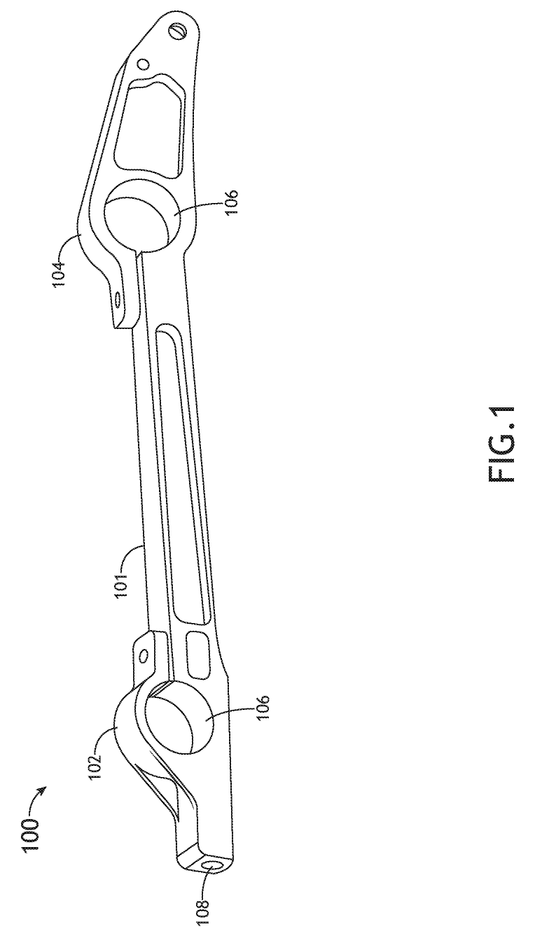

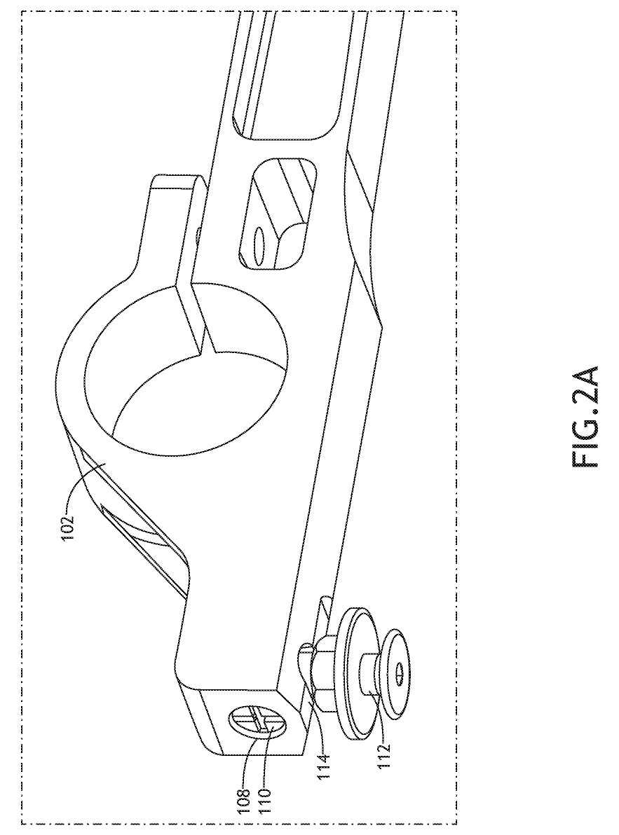

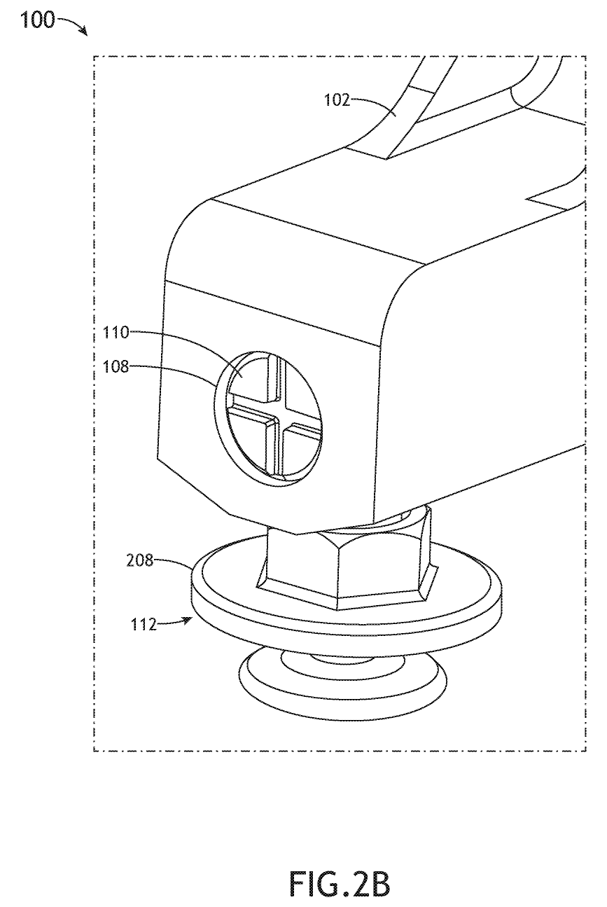

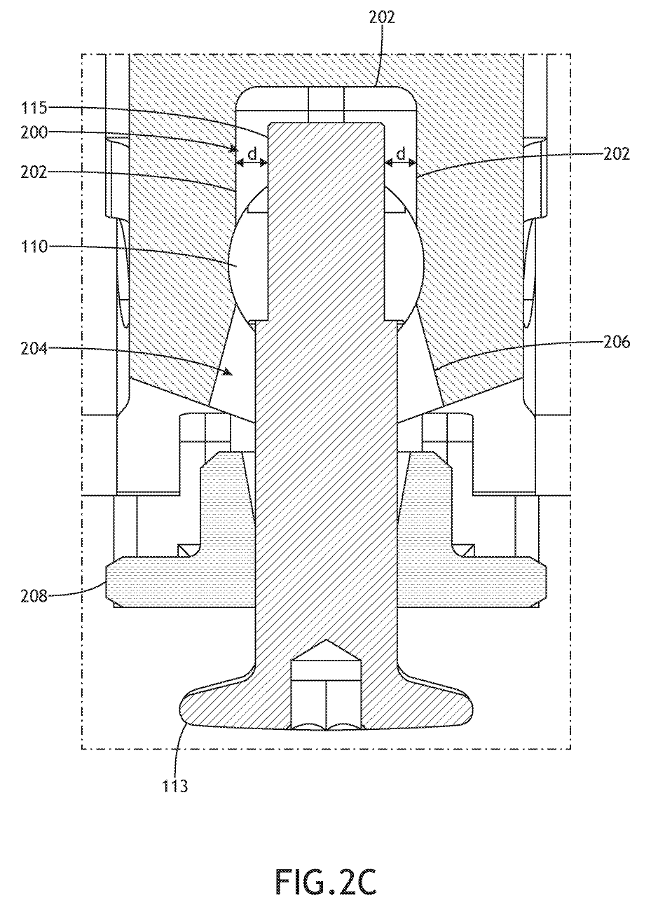

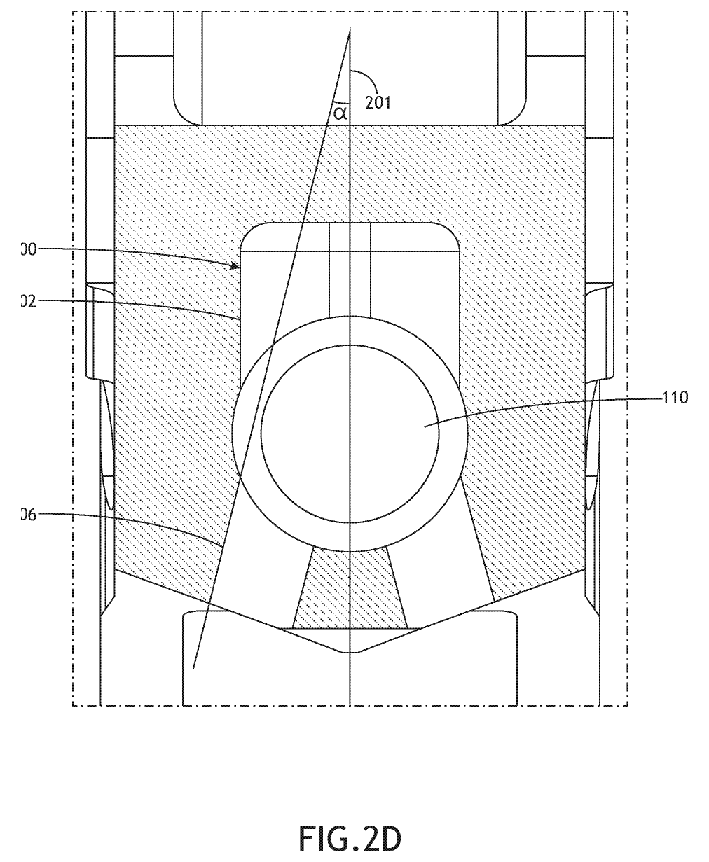

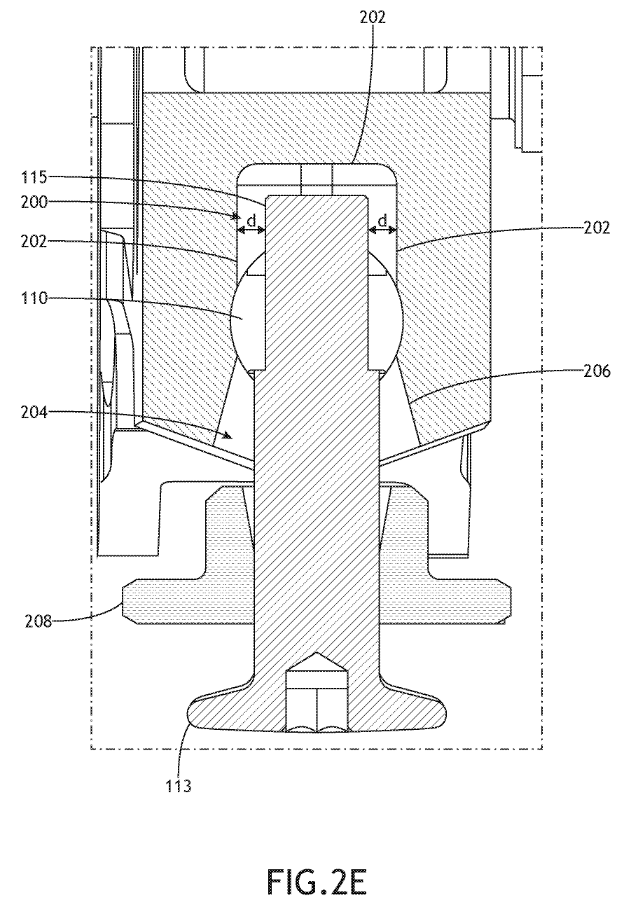

FIGS. 1-2E in general illustrate a tapered seat frame leg 100, in accordance with one or more embodiments of the disclosure. For purposes of the present disclosure, the terms “tapered seat frame leg”, “seat frame leg”, “seat leg”, “tapered leg”, and variations thereof may be used interchangeably, unless otherwise noted herein.

The leg frame 100 may include a body 101 and one or more mounting brackets 102, 104 (or mounting clips). The one or more mounting brackets (or clips) may be configured to secure the leg frame 100 to a portion of a seat frame (e.g., leg/base assembly, a seat pan, or a seatback) of an aircraft seat.

For example, the one or more mounting brackets may include at least a first mounting bracket 102 on a first end of the leg frame 100 and a second mounting bracket 104 on a second end of the leg frame 100 (opposite the first end), where the body 101 spans between the respective mounting brackets 102, 104. For instance, the first mounting bracket 102 may be arranged on a front (or forward) end of the leg frame 100 and the second mounting bracket 104 may be arranged on a back (or aft) end of the leg frame 100.

Each mounting bracket 102, 104 may include a seat mounting hole 106. For example, the seat mounting hole 106 may be configured to receive at least a portion of the seat frame (e.g., leg/base assembly, seat pan, or seatback) of an aircraft seat. In this regard, the seat mounting hole 106 may be configured to mount the leg frame 100 to at least a portion of the seat frame (e.g., leg/base assembly, seat pan, or seatback) of an aircraft seat.

The first mounting bracket 102 may include a fastener hole 108 configured to receive at least a portion of a fastener. For example, as shown in FIGS. 2A-2B, the fastener hole 108 may receive a fastener 110 to secure a track stud 112 to the leg frame 100, as will be discussed further herein. For instance, the fastener hole 108 may be arranged on a front surface of the leg frame, where a shaft of the fastener 110 may be arranged substantially parallel with the body of the leg frame 100.

The first mounting bracket 102 may include a track mounting hole 114 configured to receive at least a portion of the track stud 112. For example, as shown in FIGS. 2A-2E, the track mounting hole 114 may be configured to receive at least a portion of a shaft of the track stud 112. For instance, as shown in FIG. 2A, the track mounting hole 114 may be arranged on a bottom surface of the leg frame 100, where the track stud 112 may be arranged perpendicular to the bottom surface of the leg frame 100.

The track stud 112 may include a shaft including at least a first end 113 and a second end 115. The first end 113 of the track stud 112 may be configured to secure the aircraft seat to a track coupled to a floor of an aircraft cabin. The second end 115 of the track stud 112 may be configured to interface with the track mounting hole 114. The second end 115 of the track stud 112 may be secured to the first mounting bracket 102 via one or more fasteners (e.g., barrel nuts, or the like).

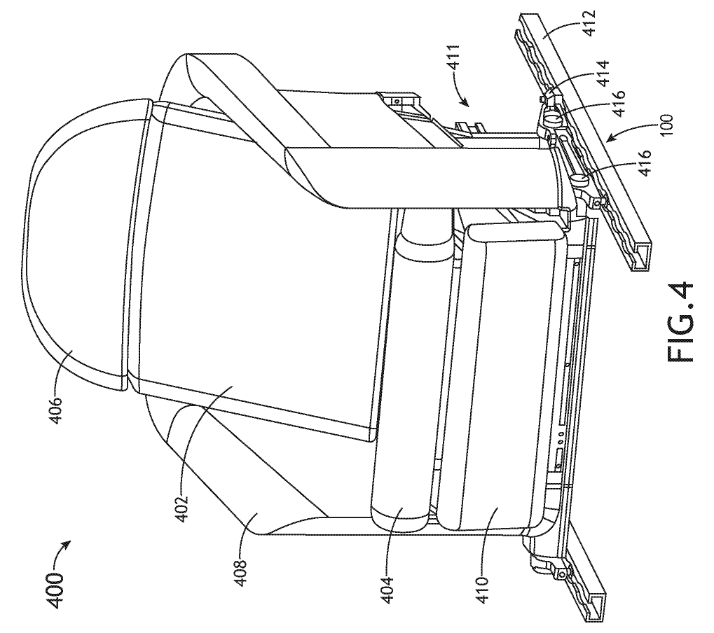

The first end 113 of the track stud 112 may be shaped to complement a lobe within the track coupled to the floor of the aircraft cabin (as shown in FIG. 4). For example, the first end 113 of the track stud 112 may include a lobe protrusion, where the lobe protrusion is complementary with the lobe of the track. In this regard, the first end 113 of the track stud 112 may be coupled to a respective lobe within the track.

Referring to FIGS. 2C-2E, the track mounting hole 108 may include a cavity 200 defined by one or more sidewalls 202 of the leg frame 100. The cavity 200 may include a tapered portion 204 defined by one or more tapered sidewalls 206. The angle of the tapered cavity 204 may be such that the load of the track stud 112 is distributed and does not contact the sidewall 202, 206 of the track mounting hole 108 when a load is applied to the tapered seat leg frame 100. For example, in a non-limiting example, as shown in FIGS. 2D-2E, the angle α of the tapered cavity 204 may be at least 15 degrees between a central axis 201 of the track stud 112 and the tapered sidewall 206. Further, a distance d between the track stud 112 and at least one sidewall of the one or more sidewalls 202 may be at least 0.04 inches, such that there is at least a 0.04-inch clearance on either side of the track stud 112.

The track stud 112 may be configured to receive a portion of an anti-rattle device 208. The anti-rattle device 208 may securely hold the leg frame 100 of the aircraft seat in place under different loading conditions while limiting movement of the leg frame 100 and minimizing transfer of loads (e.g., horizontal loads) to the track.

Although FIGS. 2A-2E depict a specific track stud 112, it is contemplated herein that the leg frame 100 of the present disclosure may be compatible with any track stud configuration including a tapered end portion.

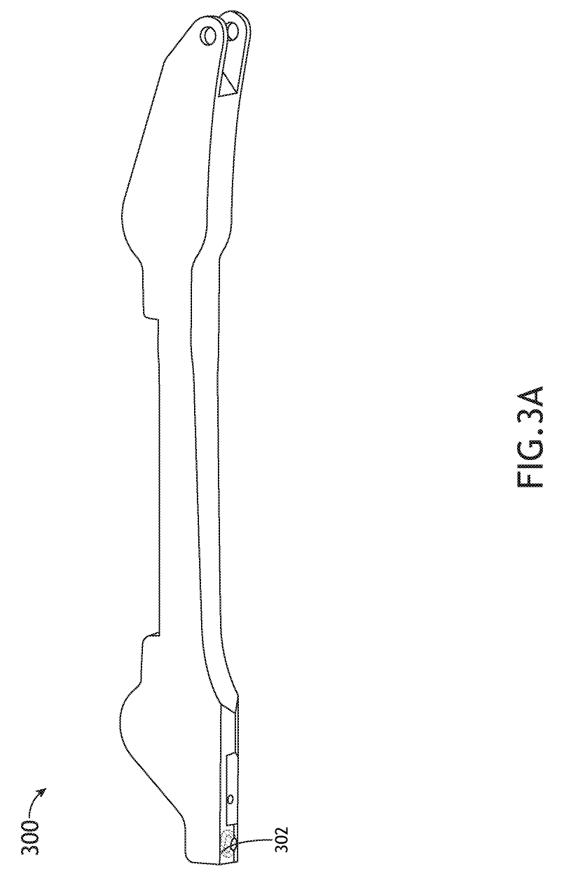

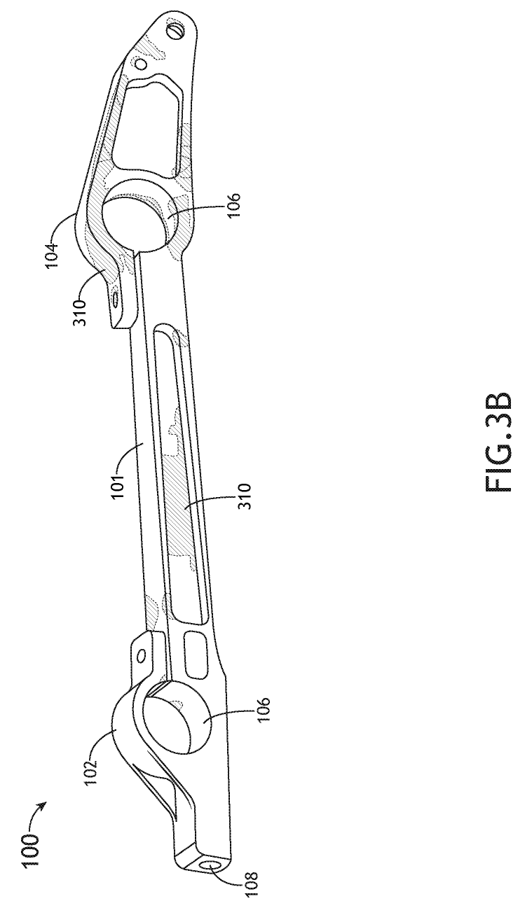

FIG. 3A illustrates a compressive strain diagram of a conventional leg frame. FIG. 3B illustrates a compressive strain diagram of the leg frame 100 of the present disclosure, in accordance with one or more embodiments of the present disclosure.

As can be seen in FIG. 3A, the front end of the conventional leg frame 300 exhibits a high amount of localized compressive strain 302 due to edge contact and bearing load, as previously discussed herein. In contrast, FIG. 3B depicts a localized compressive strain 310 due to edge contact across the body 101 of the leg frame 100 and the second mounting bracket 104.

As previously discussed herein, an advantage of the localized compressive strain of the leg frame 100 of the present disclosure is that it allows the leg frame 100 to effectively absorb and distribute loads without transferring excessive force to surrounding structures. By concentrating strain in specific areas (away from the front mounting bracket 102), the risk of widespread material fatigue or failure throughout the leg frame 100 is reduced. In this regard, the tapered design of the leg frame 100 of the present disclosure enhances the overall structural integrity and durability of the aircraft seat, contributing to improved safety and longevity under repeated loading conditions.

FIG. 4 illustrates an aircraft seat 400 including the tapered seat frame leg 100, in accordance with one or more embodiments of the present disclosure. Although FIG. 4 depicts a specific aircraft seat, it is contemplated herein that the leg frame 100 of the present disclosure may be directed towards any aircraft seat configuration including a leg frame with a tapered end portion.

The aircraft seat 400 may include, but is not limited to, a business-class or first-class passenger seat, an economy-class passenger seat, a crew member seat, or the like. It is noted that the terms “aircraft seats” and “passenger seats” may be considered equivalent, for purposes of the disclosure.

The aircraft seat 400 may include a seatback 402. The aircraft seat 400 may include a seat pan 404. The seatback 402 may include a headrest 406. For example, the headrest 406 may be integrated within the seatback 402. By way of another example, the headrest 406 may be a separate component coupled to (or inserted into) the seatback 402. For instance, the headrest 406 may be movable relative to the seatback 402 of the aircraft seat 400 (e.g., adjustable, removable, or the like). The aircraft seat 400 may include one or more arms 408.

The seat pan 404 may include a leg rest 410. For example, the leg rest 410 may be integrated within the seat pan 404. By way of another example, the leg rest 410 may be a separate component coupled to (or inserted into) the seat pan 404. For instance, the leg rest 410 may be movable relative to the seat pan 404 of the aircraft seat 400 (e.g., adjustable, removable, or the like).

The aircraft seat 400 may be coupled to a base assembly 411. The base assembly may be covered by a shroud. For example, the shroud may include one or more sections configured to cover at least a portion of the aircraft seat 400.

The base assembly 411 may include one or more leg frames 100. For example, the base assembly 411 may include a first leg frame 100 on a first side of the aircraft seat 400 and a second leg frame 100 on a second side of the aircraft seat 400.

In a non-limiting example, the one or more leg frames 100 may be configured to couple to one or more structural beams 416 (or cross-beams). The one or more structural beams 416 (or cross-beams) may traverse along a length of the aircraft seat 400, where the one or more structural beams 416 may provide structural support for the aircraft seat 400.

The one or more leg frames 100 may be configured to attach to the one or more structural beams 416 and secure to one or more tracks 412 located in the floor of the aircraft cabin via the one or more fittings 414 and one or more track studs 112, as discussed previously herein. For example, the front of each leg frame 100 may couple to the tracks 412 via the one or more track studs 112 and fasteners 110 and the back of each leg frame 100 may be coupled to the tracks 412 via the one or more fittings 414. In this regard, should the front of the leg frame 100 roll during a high load event or during a dynamic testing event, the tapered cavity within the leg frame prevents the front stud from pivoting into the tapered sidewall 206 within the cavity.

The aircraft seat 400 may include one or more seat articulating mechanisms configured to articulate at least one of the seatback 402 or the seat pan 404. In general, the aircraft seat 400 may be translatable (e.g., trackable or slidable) via the one or more seat articulating mechanisms. Further, the aircraft seat 400 may be rotatable about an axis cross-wise through the aircraft seat 400 into a position including, but not limited to, the upright or raised position, one or more lounge or reclined positions, and a lie-flat or bed position. For example, the aircraft seat 400 may transition directly between the upright or raised position and the lie-flat or bed position. By way of another example, it is noted that the aircraft seat 400 may transition through one or more lounge or reclined positions between the upright or raised position and the lie-flat or bed position. By way of another example, the aircraft seat 400 may transition into one or more lounge or reclined positions in a motion separate from the transition between the upright or raised position and the lie-flat or bed position. Therefore, the above description should not be interpreted as a limitation on the scope of the disclosure but merely an illustration.The aircraft seat 400 may be fully positionable between the outer limits of motion as defined by the moveable components of the aircraft seat 400. Where the aircraft seat 400 is installed within a passenger compartment, the aircraft seat 400 may be fully positionable between the outer limits of motion as defined by one or more passenger compartment monuments of the passenger compartment. It is noted an upright or raised position may be considered a taxi, takeoff, or landing (TTL) position during select stages of flight (though the upright or raised position is not limited to use during the select stages of flight as the TTL position, but also may be used at any point during the flight), for purposes of the present disclosure. In addition, it is noted that any position that does not meet the above-defined requirements of the TTL position may be considered a non-TTL position, for purposes of the present disclosure. Further, it is noted that the aircraft seat 400 may be actuatable (e.g., translatable and/or rotatable) from the TTL position to a non-TTL position, and/or vice versa. Further, it is noted that the aircraft seat 400 may be capable of a fully upright or raised position, and that the TTL position may have a more reclined seatback cushion and a more angled upward seat pan cushion as compared to the fully upright or raised position. Therefore, the above description should not be interpreted as a limitation on the present disclosure but merely an illustration.

Although embodiments of the disclosure are directed to an aviation environment, it is noted herein that the tapered seat leg frame is not limited to use in an aviation environment. Therefore, the above description should not be interpreted as a limitation on the present disclosure but merely an illustration.

Although the disclosure has been described with reference to the embodiments illustrated in the attached drawing figures, equivalents may be employed and substitutions made herein without departing from the scope of the claims. Components illustrated and described herein are merely examples of a system/device and components that may be used to implement embodiments of the disclosure and may be replaced with other devices and components without departing from the scope of the claims. Furthermore, any dimensions, degrees, and/or numerical ranges provided herein are to be understood as non-limiting examples unless otherwise specified in the claims

What is claimed is:

1. A tapered seat leg frame comprising:
a first mounting bracket, wherein the first mounting bracket includes a track mounting hole, wherein the track mounting hole includes a cavity defined by one or more sidewalls, wherein the cavity includes a tapered portion;
a second mounting bracket arranged opposite the first mounting bracket; and
a track stud including a shaft including at least a first end and a second end, wherein the cavity of the track mounting hole is configured to receive at least a portion of the shaft of the track stud, wherein at least the portion of the shaft of the track stud is configured to contact the tapered portion of the cavity when a load is applied to the tapered seat leg frame.

2. The tapered seat leg frame of claim 1, wherein an angle of the cavity between a central axis of the track stud and a tapered sidewall within the tapered portion of the cavity is 15 degrees.

3. The tapered seat leg frame of claim 1, wherein a distance between an edge of a shaft of the track stud and a sidewall within the cavity of the track mounting hole is at least 0.04 inches.

4. The tapered seat leg frame of claim 1, wherein the first mounting bracket further includes:
a fastener hole configured to receive a fastener, wherein the fastener is configured to secure the track stud within the cavity of the track mounting hole and the fastener hole.

5. The tapered seat leg frame of claim 4, wherein the fastener comprises:
a barrel nut.

6. The tapered seat leg frame of claim 1, wherein the track stud is coupled to an anti-rattle device, wherein the anti-rattle device is configured to securely hold the tapered seat leg frame in place during one or more loading conditions.

7. The tapered seat leg frame of claim 1, wherein the first end of the track stud is configured to couple to a track on a floor of an aircraft cabin.

8. The tapered seat leg frame of claim 7, wherein the first end of the track stud includes a lobe protrusion, wherein a shape of the lobe protrusion is complementary to a lobe shape of a track.

9. An aircraft seat comprising:
a seat frame including a seatback and a seat pan; and
a base assembly configured to couple the seat frame to a floor of an aircraft cabin, wherein the base assembly comprises one or more tapered seat leg frames, wherein each tapered seat leg frame comprises:
a first mounting bracket, wherein the first mounting bracket includes a track mounting hole, wherein the track mounting hole includes a cavity defined by one or more sidewalls, wherein the cavity includes a tapered portion;
a second mounting bracket arranged opposite the first mounting bracket; and
a track stud including a shaft including at least a first end and a second end, wherein the cavity of the track mounting hole is configured to receive at least a portion of the shaft of the track stud, wherein at least the portion of the shaft of the track stud is configured to contact the tapered portion of the cavity when a load is applied to each tapered seat leg frame.

10. The aircraft seat of claim 9, wherein the base assembly further comprises:
one or more structural beams configured to couple the seat frame to the floor of the aircraft cabin via the one or more tapered seat leg frames.

11. The aircraft seat of claim 10, wherein an angle of the cavity between a central axis of the track stud and a tapered sidewall within the tapered portion of the cavity is 15 degrees.

12. The aircraft seat of claim 10, wherein a distance between an edge of the shaft of the track stud and a sidewall within the cavity of the track mounting hole is at least 0.04 inches.

13. The aircraft seat of claim 10, wherein the first mounting bracket further includes:
a fastener hole configured to receive a fastener, wherein the fastener is configured to secure the track stud within the cavity of the track mounting hole and the fastener hole.

14. The aircraft seat of claim 13, wherein the fastener comprises:
a barrel nut.

15. The aircraft seat of claim 10, wherein the track stud is coupled to an anti-rattle device, wherein the anti-rattle device is configured to securely hold each tapered seat leg frame in place during one or more loading conditions.

16. The aircraft seat of claim 9, wherein the first end of the track stud is configured to couple to a track on the floor of the aircraft cabin.

17. The aircraft seat of claim 16, wherein the first end of the track stud includes a lobe protrusion, wherein a shape of the lobe protrusion is complementary to a lobe shape of a track.
